(19) United States
(12) Patent Application Publication
(10) Pub. No.: US 2026/0199984 A1
(43) Pub. Date: Jul. 16, 2026

(54) BAR FEEDER

(71) Applicant: IKURA SEIKI CO., LTD., Ibaraki (JP)

(72) Inventors: Kiyoshi HIROSAWA, Ibaraki (JP); Eiji SONE, Ibaraki (JP); Koji NAKASATO, Ibaraki (JP)

(21) Appl. No.: 19/448,814

(22) Filed: Jan. 14, 2026

(30) Foreign Application Priority Data
Jan. 15, 2025 (JP) 2025-005377

(51) Int. Cl. B23B 13/10; B23B 13/12

(52) U.S. Cl. CPC B23B 13/10; B23B 13/123

(57) ABSTRACT

A bar feeder includes: a plurality of bar guide shelves each of which is inclined relative to a horizontal direction, a plurality of stopper portions each of which is provided at a lower end of a corresponding bar guide shelf, a plurality of push-up members each of which is provided to push up a single bar that has been guided to a lower end of a corresponding bar guide shelf in order to cause the single bar to pass over a corresponding stopper portion, a plurality of regulating members each of which is provided above an upper surface of the corresponding bar guide shelf and is vertically movable, and a support mechanism configured to support the plurality of regulating members. The plurality of regulating members is integrally connected to each other such that the plurality of regulating members is integrally positioned at a desired height relative to the support mechanism.

### TECHNICAL FIELD

The present invention pertains to a bar feeder for feeding bars (bar materials) one by one.

### BACKGROUND ART

FIGS. 19 to 21 are a schematic plan view, a schematic front view, and a schematic cross-sectional view, respectively, showing a conventional bar feeder 100.

As shown in FIGS. 19 to 21, the bar feeder 100 includes five bar guide shelves 111 to 115, each of which is inclined at approximately 20 degrees relative to a horizontal direction. Each of the bar guide shelves 111 to 115 is a narrow-width member (e.g., a member having a width of approximately 3 mm) (which may also be referred to as a “bar guide rail”).

FIG. 22 is an enlarged view of the essential part of FIG. 21. As shown in FIG. 22, a corresponding stopper portion 121 to 125 is provided at a lower end of each of the bar guide shelves 111 to 115. Furthermore, as shown in FIGS. 23A and 23B, a corresponding push-up member 131 to 135 is provided to push up a single bar (bar material) that has been guided to the lower end of each of the bar guide shelves 111 to 115 from the lower side to the upper side, causing it to pass over the corresponding stopper portion 121 to 125.

Meanwhile, returning to FIG. 22, a corresponding regulating member 141 to 145 is provided above an upper surface of each of the bar guide shelves 111 to 115. Each of the regulating members 141 to 145 is supported by a support mechanism 150 such that it can be vertically moved relative to the support mechanism 150. Each of the regulating members 141 to 145 is also a narrow-width member (e.g., a member having a width of approximately 3 mm). A bottom surface of each of the regulating members 141 to 145 is maintained in parallel alignment with the corresponding bar guide shelf 111 to 115. As shown in FIGS. 24A and 24B, the height of each of the regulating members 141 to 145 can be adjusted depending on the diameter of each of the bars to be fed. This adjustment enables smooth guidance of the bars. Particularly, this adjustment enables an effective avoidance of a state in which two bars are overlapped vertically during guidance.

More specifically, each of the regulating members 141 to 145 has a corresponding sliding slot hole 141s to 145s, which is configured to slide relative to the support mechanism 150 in a substantially vertical direction (more precisely, at an angle of approximately 5 degrees inclined from a vertical direction).

A user of the bar feeder 100 can manually slide the position of each of the regulating members 141 to 145 to adjust its height according to the diameter of the bars. Subsequently, the position of each of the regulating members 141 to 145 relative to the support mechanism 150 is fixed by tightening a corresponding locking lever 151 to 155 (its height becomes adjustable again by loosening the corresponding locking lever 151 to 155).

Although not highly relevant to the present invention, a bar feeder that had been developed by the applicant of the present application has been granted a patent (JP 7148148 B).

### Prior Art Document List

### Patent Document

Patent Document 1 JP 7148148 B

### Summary of Invention

### Technical Problem to be solved by Invention

In the aforementioned conventional bar feeder 100, when adjusting the heights of the regulating members 141 to 145 according to the diameter of the bars, it was necessary to manually slide the positions of the regulating members 141 to 145. That is, it was necessary to manually slide each of the regulating members 141 to 145.

Herein, if the five regulating members 141 to 145 could be slid integrally, the task of positioning the regulating members 141 to 145 (the task of adjusting the heights of the regulating members 141 to 145) would be facilitated.

The present invention has been made based on the above findings by the inventors. An object of the present invention is to provide a bar feeder in which the task of positioning a plurality of regulating members is facilitated by integrally connecting the plurality of regulating members.

Alternatively, if a plurality of positioning mechanisms is respectively provided correspondingly to a plurality of regulating members, another object of the present invention is to provide a bar feeder in which the task of positioning the plurality of regulating members is facilitated by causing the plurality of positioning mechanisms to synchronously function together.

### Means for solving Problem

A first aspect of the present invention is a bar feeder including: a plurality of bar guide shelves, each of which is inclined relative to a horizontal direction; a plurality of stopper portions, each of which is provided at a lower end of a corresponding bar guide shelf of the plurality of bar guide shelves; a plurality of push-up members, each of which is provided to push up a single bar that has been guided to a lower end of a corresponding bar guide shelf of the plurality of bar guide shelves from a lower side to an upper side in order to cause the single bar to pass over a corresponding stopper portion of the plurality of stopper portions; a plurality of regulating members, each of which is provided above an upper surface of the corresponding bar guide shelf and is vertically movable; and a support mechanism configured to support the plurality of regulating members; wherein the plurality of bar guide shelves is arranged along a longitudinal direction of a bar to be fed, the plurality of regulating members is also arranged along the longitudinal direction of the bar to be fed, and the plurality of regulating members is integrally connected to each other such that the plurality of regulating members is integrally positioned at a desired height relative to the support mechanism.

According to the above first aspect, because the plurality of regulating members is integrally connected to each other such that the plurality of regulating members is integrally positioned at a desired height relative to the support mechanism, the task of positioning the plurality of regulating members can be significantly facilitated.

It is preferable that each of the plurality of regulating members is configured to be slidable relative to the support mechanism.

According to this preferable feature, the task of positioning the plurality of regulating members can be further facilitated. In addition, it is possible to implement such a structure for positioning (adjusting the height of) the plurality of regulating members at a lower cost.

Furthermore, it is preferable that positioning of the plurality of regulating members is possible only when a locking lever is released.

According to this preferable feature, the positions of the plurality of regulating members after having been positioned can be stably maintained by actuation of the locking lever.

In addition, it is preferable that the plurality of regulating members is slidable along a track that enables not only bars having a circular cross-sectional shape but also bars having various other cross-sectional shapes to be stably pushed up by the plurality of push-up members and to pass over the plurality of stopper portions.

Specifically, it is preferable that each of the plurality of regulating members is configured to be slidable at an angle of 70 to 80 degrees relative to the corresponding bar guide shelf (if each of the plurality of regulating members is configured to be slidable at an angle of 90 degrees relative to the corresponding bar guide shelf, especially when the bars to be fed have a hexagonal cross-section, the step (action) of pushing up the bars by the corresponding push-up member to pass over the corresponding stopper portion may become unstable).

A second aspect of the present invention is a bar feeder including: a plurality of bar guide shelves, each of which is inclined relative to a horizontal direction; a plurality of stopper portions, each of which is provided at a lower end of a corresponding bar guide shelf of the plurality of bar guide shelves; a plurality of push-up members, each of which is provided to push up a single bar that has been guided to a lower end of a corresponding bar guide shelf of the plurality of bar guide shelves from a lower side to an upper side in order to cause the single bar to pass over a corresponding stopper portion of the plurality of stopper portions; a plurality of regulating members, each of which is provided above an upper surface of the corresponding bar guide shelf and is vertically movable; a support mechanism configured to support the plurality of regulating members; and a plurality of positioning mechanisms, each of which is configured to position a corresponding regulating member of the plurality of regulating members to a desired height relative to the support mechanism; wherein the plurality of bar guide shelves is arranged along a longitudinal direction of a bar to be fed, the plurality of regulating members is also arranged along the longitudinal direction of the bar to be fed, and the plurality of positioning mechanisms is configured to synchronously function together such that the plurality of regulating members is integrally positioned at a desired height relative to the support mechanism.

According to the above second aspect, because the plurality of positioning mechanisms is configured to synchronously function together such that the plurality of regulating members is integrally positioned at a desired height relative to the support mechanism, the task of positioning the plurality of regulating members can be significantly facilitated.

It is preferable that the plurality of positioning mechanisms is configured to synchronously function together via a cofunctioning shaft.

According to this preferable feature, the step (action) of causing the plurality of positioning mechanisms to synchronously function together can be facilitated. In addition, it is possible to implement such a structure at a lower cost for causing the plurality of positioning mechanisms to synchronously function together.

In addition, it is preferable that each of the plurality of regulating member is configured to be slidable relative to the support mechanism.

According to this preferable feature, the task of positioning the plurality of regulating members can be facilitated. In addition, it is possible to implement such a structure for positioning (adjusting the height of) the plurality of regulating members at a lower cost.

In addition, it is preferable that each of the plurality of positioning mechanisms has a locking lever.

According to this preferable feature, the positions of the plurality of regulating members after having been positioned can be stably maintained by actuation of the locking lever.

In addition, it is preferable that each of the plurality of positioning mechanisms has a pinion gear fixed to the cofunctioning shaft.

According to this preferable feature, the task of positioning the plurality of regulating members with a higher degree of accuracy can be facilitated. In addition, it is possible to implement such a structure at a lower cost for positioning (adjusting the positions of) the plurality of regulating members with a higher degree of accuracy.

In this case, it is more preferable that the cofunctioning shaft is configured to be rotated via an adjustment knob.

According to this more preferable feature, the task of positioning the plurality of regulating members with a higher degree of accuracy can be further facilitated. In addition, it is possible to implement such a structure at a lower cost for positioning (adjusting the positions of) the plurality of regulating members with a higher degree of accuracy.

In this case, it is further preferable that the bar feeder further includes a scale indicating an index corresponding to a rotational amount of the adjustment knob.

According to this further preferable feature, the task of positioning the plurality of regulating members with a higher degree of accuracy can be further facilitated. For example, it is preferable that the index may denote numerical values corresponding to the diameter of the bars to be fed.

In the second aspect as well as the first aspect, it is preferable that the plurality of regulating members is slidable along a track that enables not only bars having a circular cross-sectional shape but also bars having various other cross-sectional shapes to be stably pushed up by the plurality of push-up members and to pass over the plurality of stopper portions.

Specifically, it is preferable that each of the plurality of regulating members is configured to be slidable at an angle of 70 to 80 degrees relative to the corresponding bar guide shelf (if each of the plurality of regulating members is configured to be slidable at an angle of 90 degrees relative to the corresponding bar guide shelf, especially when the bars to be fed have a hexagonal cross-section, the step (action) of pushing up the bars by the corresponding push-up member to pass over the corresponding stopper portion may become unstable).

### Effects of Invention

According to the bar feeder of the first aspect of the present invention, because the plurality of regulating members is integrally connected to each other such that the plurality of regulating members is integrally positioned at a desired height relative to the support mechanism, the task of positioning the plurality of regulating members can be significantly facilitated.

According to the bar feeder of the second aspect of the present invention, because the plurality of positioning mechanisms is configured to synchronously function together such that the plurality of regulating members is integrally positioned at a desired height relative to the support mechanism, the task of positioning the plurality of regulating members can be significantly facilitated.

### BRIEF DESCRIPTION OF DRAWINGS

FIG. 1 is a schematic plan view of a bar feeder according to a first embodiment of the present invention;

FIG. 2 is a schematic front view of the bar feeder according to the first embodiment of the present invention;

FIG. 3 is a schematic cross-sectional view of the bar feeder according to the first embodiment of the present invention;

FIG. 4 is an enlarged view of an essential part of FIG. 3;

FIGS. 5A and 5B are schematic views for explaining an operation of a push-up member according to the first embodiment of the present invention;

FIGS. 6A and 6B are schematic views for explaining a height adjustment of a regulating member according to the first embodiment of the present invention;

FIG. 7 is an enlarged plan view of a part of FIG. 1;

FIG. 8 is a schematic plan view of a bar feeder according to a second embodiment of the present invention;

FIG. 9 is a schematic front view of the bar feeder according to the second embodiment of the present invention;

FIG. 10 is a schematic cross-sectional view of the bar feeder according to the second embodiment of the present invention;

FIG. 11 is an enlarged view of an essential part of FIG. 10;

FIGS. 12A and 12B are schematic views for explaining an operation of a push-up member according to the second embodiment of the present invention;

FIGS. 13A and 13B are schematic views for explaining a height adjustment of a regulating member according to the second embodiment of the present invention;

FIG. 14 is an enlarged plan view of a part of FIG. 8;

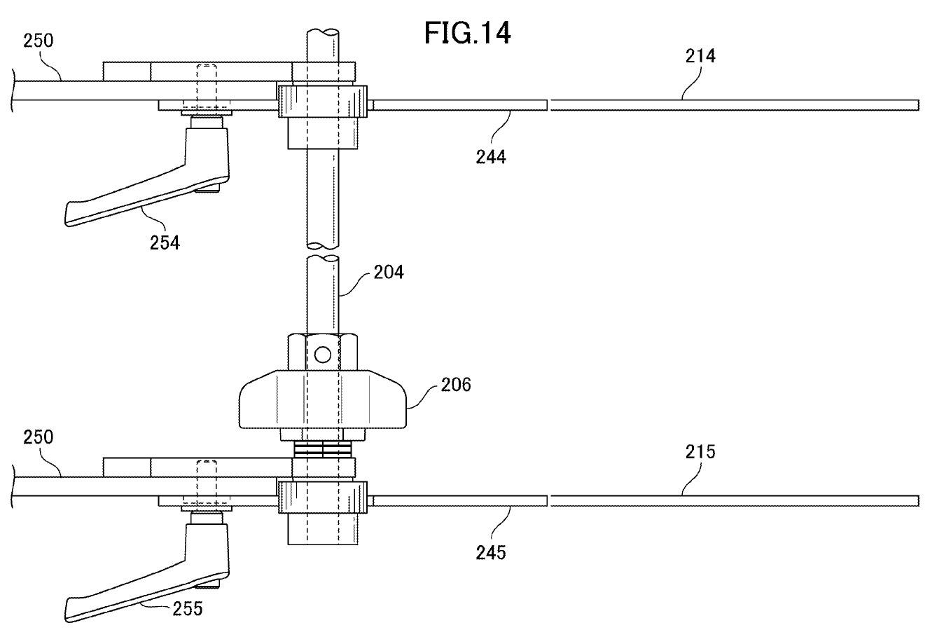

FIG. 15 is a photograph corresponding to a perspective view of the bar feeder according to the second embodiment of the present invention;

FIG. 16 is a photograph corresponding to a perspective view showing an example of a scale according to the second embodiment of the present invention;

FIG. 17 is a photograph corresponding to a perspective view showing an example of an adjustment knob according to the second embodiment of the present invention;

FIG. 18 is a photograph corresponding to an exploded view showing an example of a pinion gear according to the second embodiment of the present invention;

FIG. 19 is a schematic plan view of a conventional bar feeder;

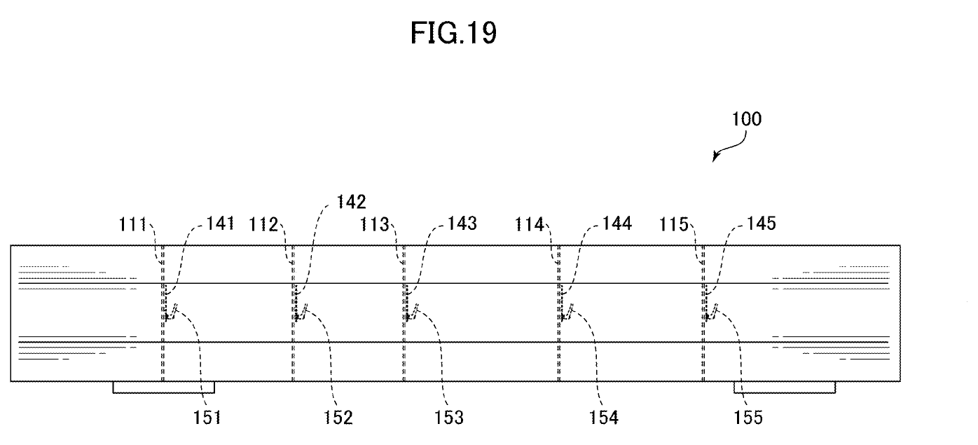

FIG. 20 is a schematic front view of the conventional bar feeder;

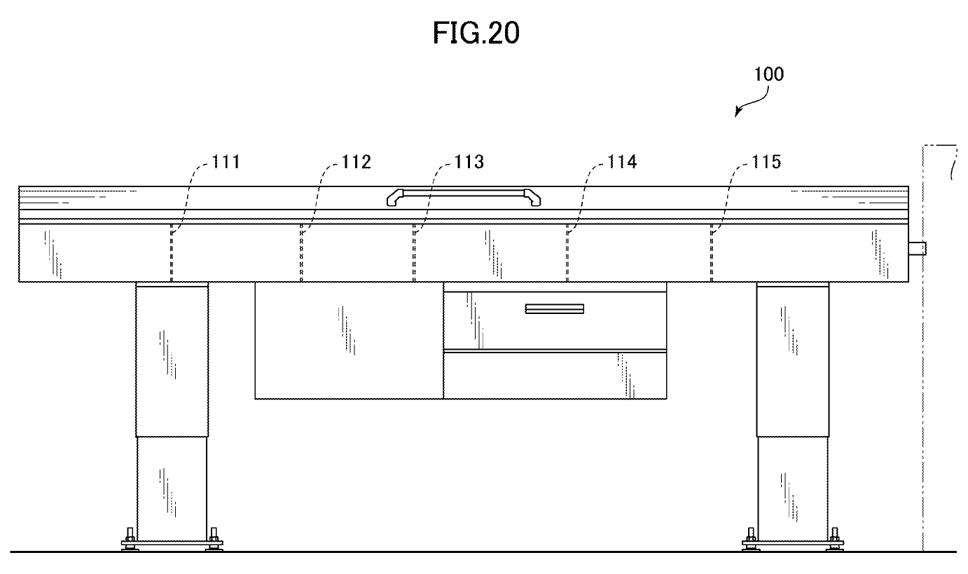

FIG. 21 is a schematic cross-sectional view of the conventional bar feeder;

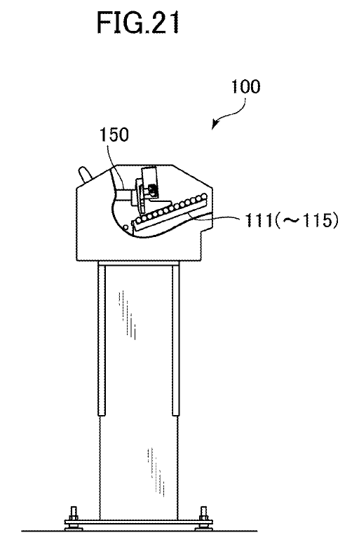

FIG. 22 is an enlarged view of an essential part of FIG. 21;

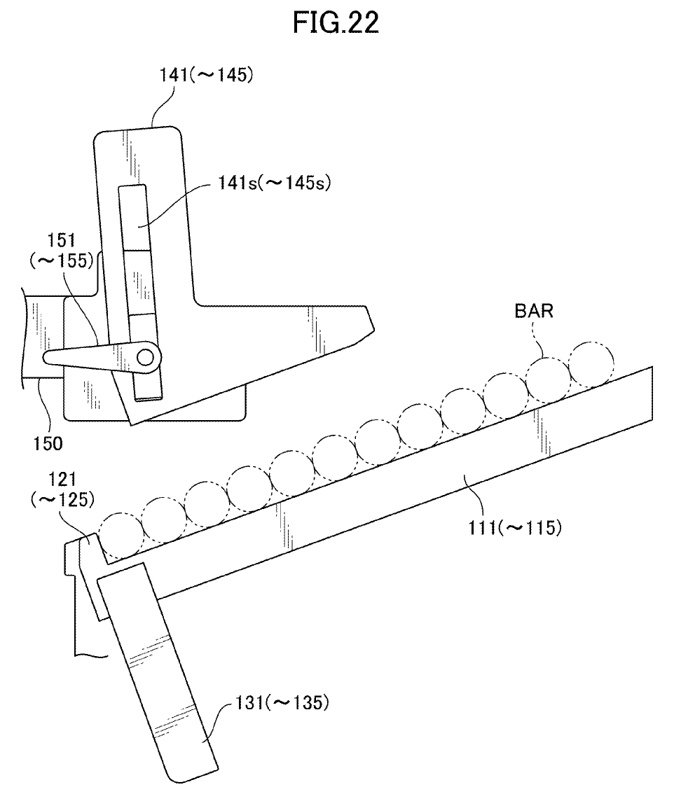

FIGS. 23A and 23B are schematic views for explaining an operation of a push-up member in the conventional bar feeder; and

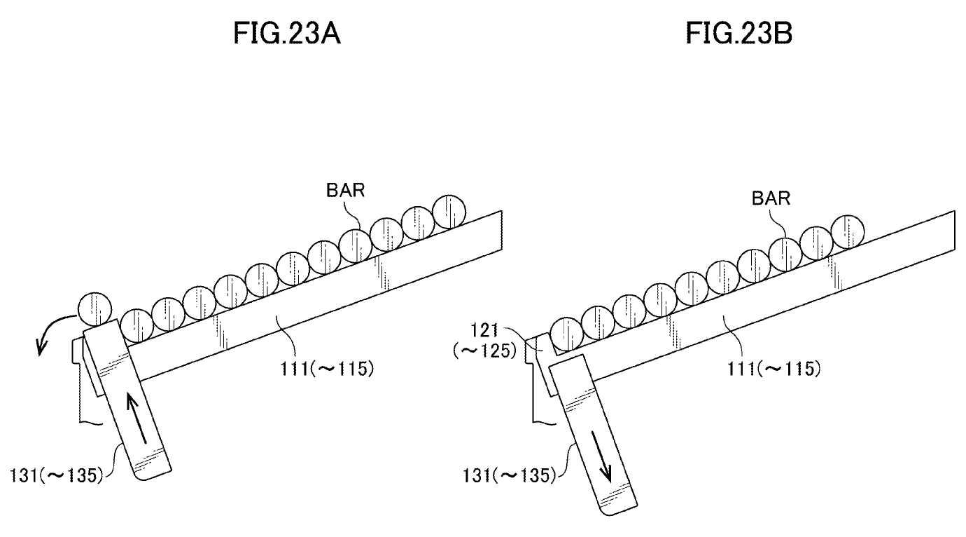

FIGS. 24A and 24B are schematic views for explaining a height adjustment of a regulating member in the conventional bar feeder.

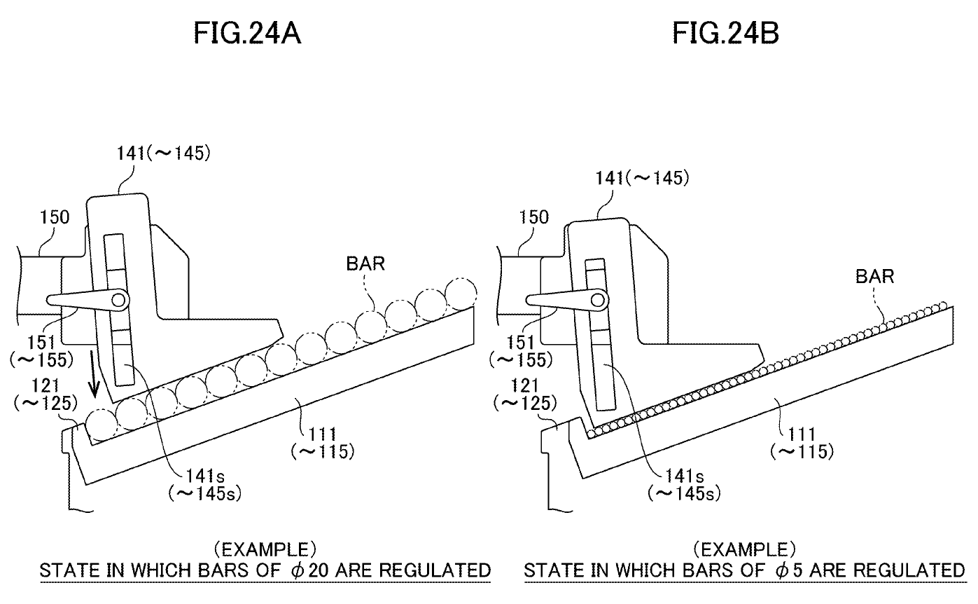

### Embodiments of Invention

### Structure of First Embodiment

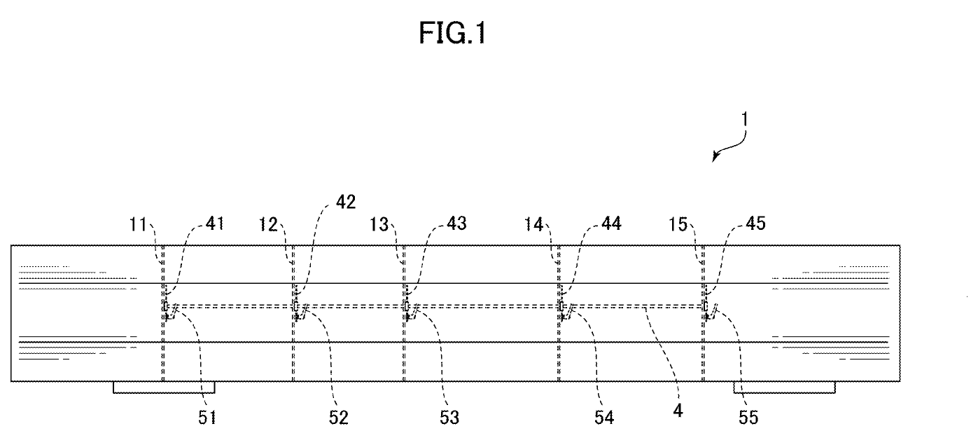

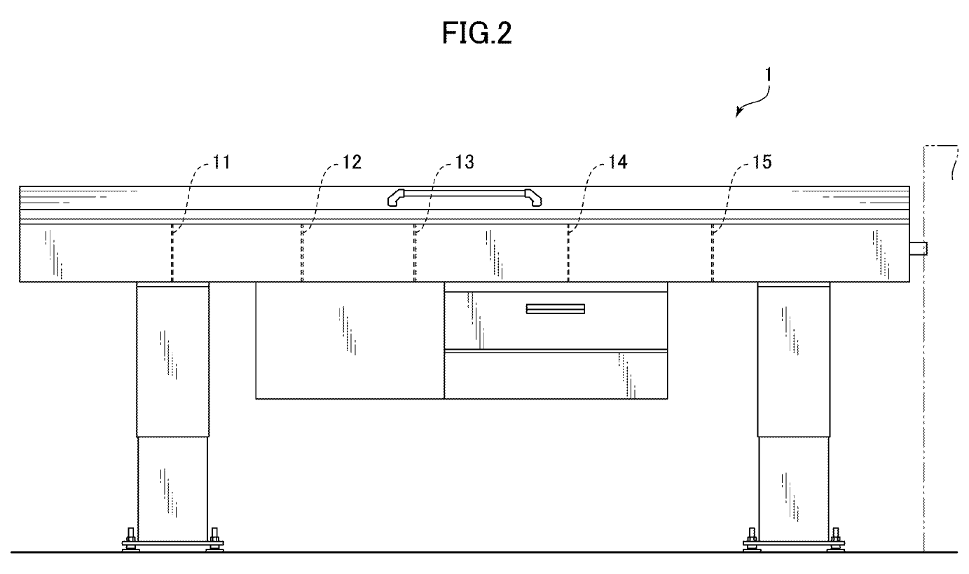

FIGS. 1 to 3 are a schematic plan view, a schematic front view, and a schematic cross-sectional view, respectively, showing a bar feeder 1 according to a first embodiment of the present invention.

As shown in FIGS. 1 to 3, the bar feeder 1 includes five bar guide shelves 11 to 15, each of which is inclined at approximately 20 degrees relative to a horizontal direction. The number of bar guide shelves is not limited to five. Each of the bar guide shelves 11 to 15 is a narrow-width member (e.g., a member having a width of approximately 3 mm) (which may also be referred to as a “bar guide rail”).

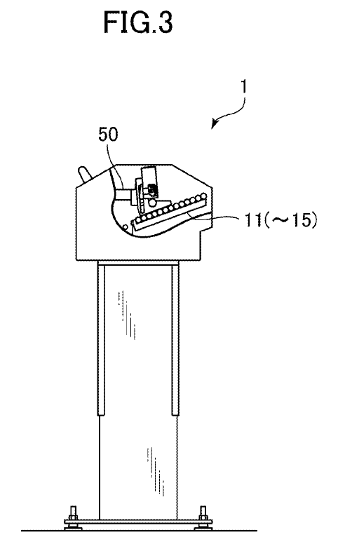

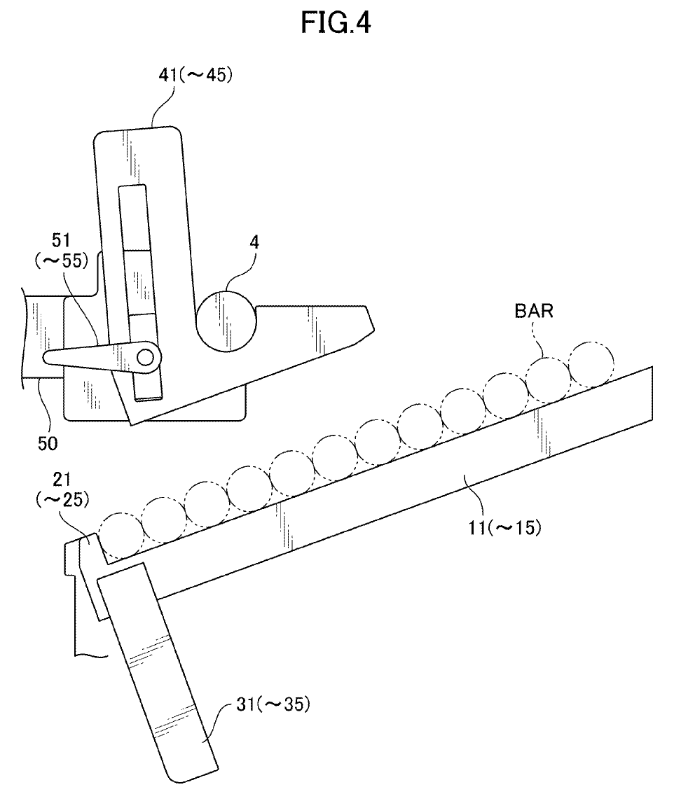

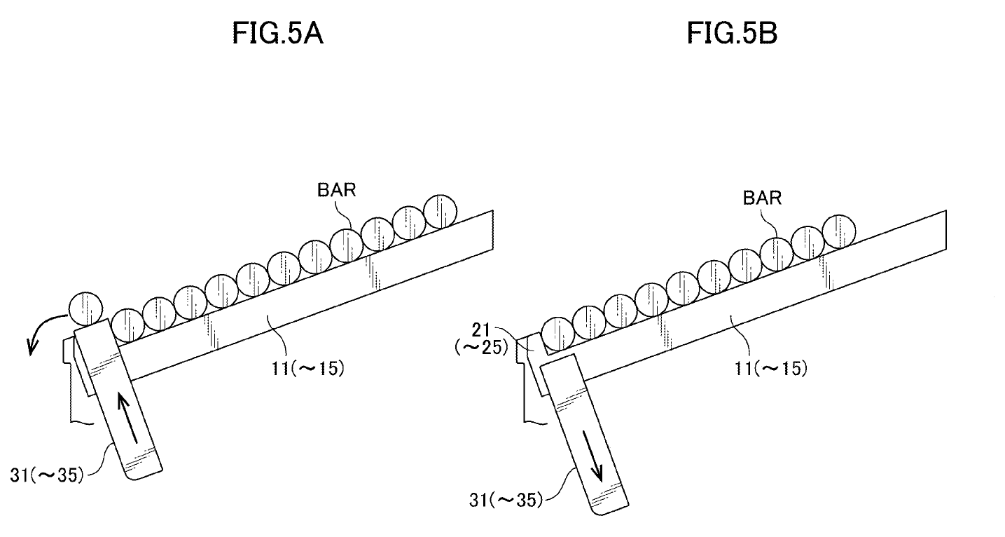

FIG. 4 is an enlarged view of the essential part of FIG. 3. As shown in FIG. 4, a corresponding stopper portion 21 to 25 is provided at a lower end of each of the bar guide shelves 11 to 15. Furthermore, as shown in FIGS. 5A and 5B, a corresponding push-up member 31 to 35 is provided to push up a single bar (bar material) that has been guided to the lower end of each of the bar guide shelves 11 to 15 from the lower side to the upper side, causing it to pass over the corresponding stopper portion 21 to 25.

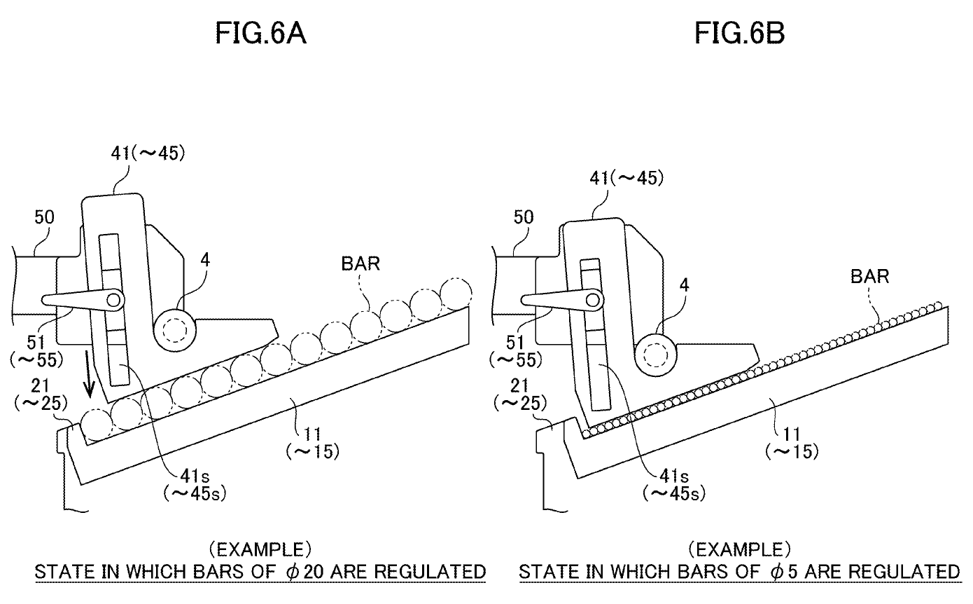

Meanwhile, returning to FIG. 4, a corresponding regulating member 41 to 45 is provided above an upper surface of each of the bar guide shelves 11 to 15. Each of the regulating members 41 to 45 is supported by a support mechanism 50 such that it can be vertically moved relative to the support mechanism 50. Each of the regulating members 41 to 45 is also a narrow-width member (e.g., a member having a width of approximately 3 mm). A bottom surface of each of the regulating members 41 to 45 is maintained in parallel alignment with the corresponding bar guide shelf 11 to 15. As shown in FIGS. 6A and 6B, the height of each of the regulating members 41 to 45 can be adjusted depending on the diameter of each of the bars to be fed. This adjustment enables smooth guidance of the bars.

More specifically, each of the regulating members 41 to 45 has a corresponding sliding slot hole 41s to 45s, which is configured to slide relative to the support mechanism 50 in a substantially vertical direction (more precisely, at an angle of approximately 5 degrees inclined from a vertical direction). Thereby, each of the plurality of regulating members 41 to 45 is configured to be slidable at an angle of approximately 75 degrees relative to the corresponding bar guide shelf 11 to 15 (which is inclined at approximately 20degrees relative to the horizontal direction). Accordingly, not only bars having a circular cross-sectional shape but also bars having various other cross-sectional shapes (for example, a hexagonal cross-sectional shape) can be stably pushed up by the plurality of push-up members 31 to 35 to pass over the plurality of stopper portions 21 to 25.

A user of the bar feeder 1 can manually slide the position of each of the regulating members 41 to 45 to adjust its height depending on the diameter of the bars.

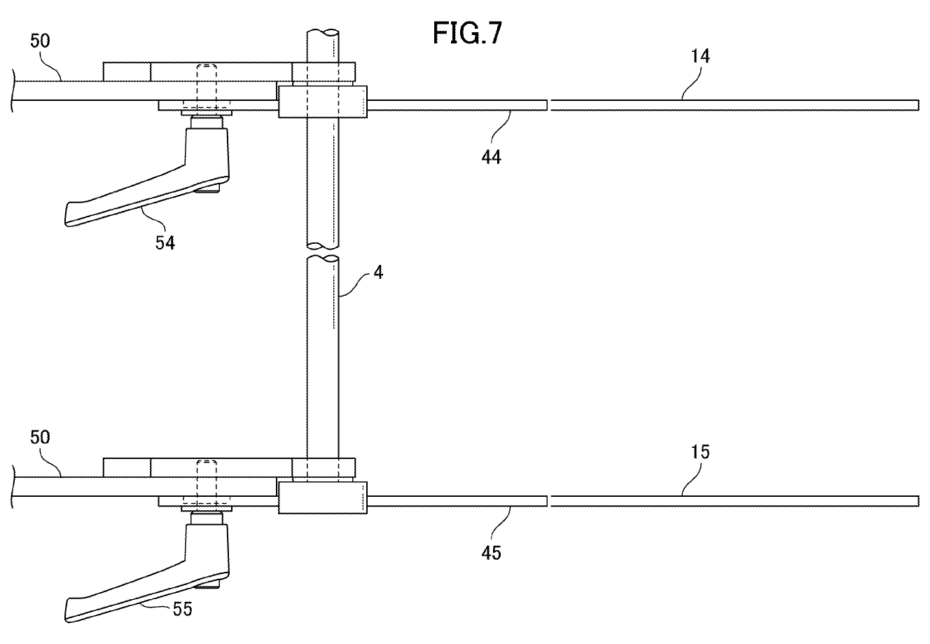

In the present embodiment, as shown in FIGS. 1 and 7, the five regulating members 41 to 45 are integrally joined (connected) by a linkage shaft 4. Accordingly, the five regulating members 41 to 45 can be integrally positioned at a desired height relative to the support mechanism 50.

In addition, the position of each of the regulating members 41 to 45 relative to the support mechanism 50 is fixable by tightening a corresponding locking lever 51 to 55 (the position (its height) becomes adjustable again by loosening the corresponding locking lever 51 to 55). The regulating members 41 to 45 and the linkage shaft 4 are biased downward by their own weight. Therefore, their downward sliding movement can be achieved simply by releasing the locking levers 51 to 55.

### Effects of First Embodiment

According to the bar feeder 1 of the present embodiment, as described above, the height of each of the regulating members 41 to 45 can be adjusted depending on the diameter of the bars to be fed (see FIGS. 6A and 6B), and therefore the smooth guidance of the bars can be accomplished. In particular, this adjustment can be effective in avoiding a state in which two bars are overlapped vertically during the guidance.

In addition, according to the bar feeder 1 of the present embodiment, because the five regulating members 41 to 45 are integrally connected to each other by the linkage shaft 4 such that the five regulating members 41 to 45 are integrally positioned at a desired height relative to the support mechanism 50, the task of positioning the five regulating members 41 to 45 can be significantly facilitated.

Furthermore, according to the bar feeder 1 of the present embodiment, because each of the regulating members 41 to 45 is configured to be slidable relative to the support mechanism 50, the task of positioning the plurality of regulating members 41 to 45 can be further facilitated. In addition, it is possible to implement this type of structure at a lower cost for positioning (adjusting the heights of) the regulating members 41 to 45.

In addition, according to the bar feeder 1 of the present embodiment, the positioning step of the five regulating members 41 to 45 is possible only when the locking levers 51 to 55 are released. Therefore, the positions of the five regulating members 41 to 45 after having been positioned can be stably maintained by actuation of the locking levers 51 to 55.

The diameter of the bars that the bar feeder 1 of the present embodiment can handle is approximately 1 mm to 38 mm (φ 1 to φ 38), and the length of the bars that the bar feeder 1 of the present embodiment can handle is approximately 1 m to 4 m. Furthermore, the material of the bars is not particularly limited, but is, for example, iron.

### Modified Example of First Embodiment

In the structure described above, the five locking levers 51 to 55 are provided correspondingly to the respective regulating members 41 to 45. However, in view of their function, just one locking lever is sufficient, which means that the number of locking levers can be appropriately reduced.

Alternatively, other known locking mechanism(s) may be adopted instead of the locking levers 51 to 55.

### Structure of Second Embodiment

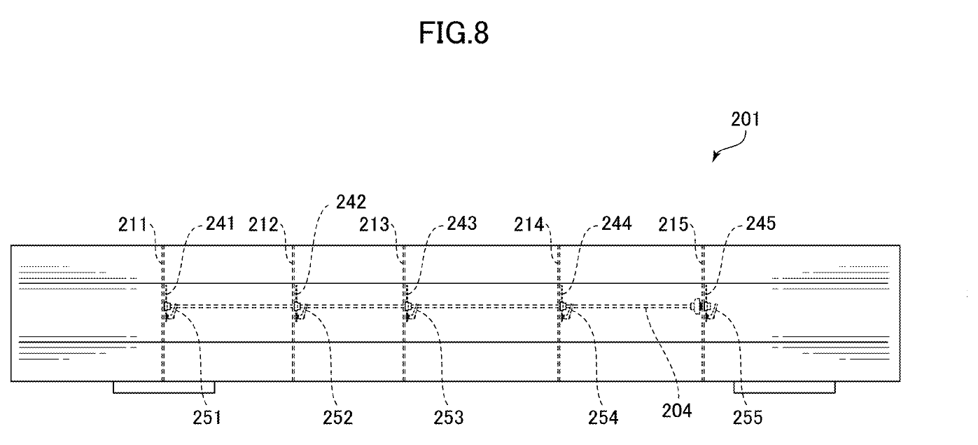

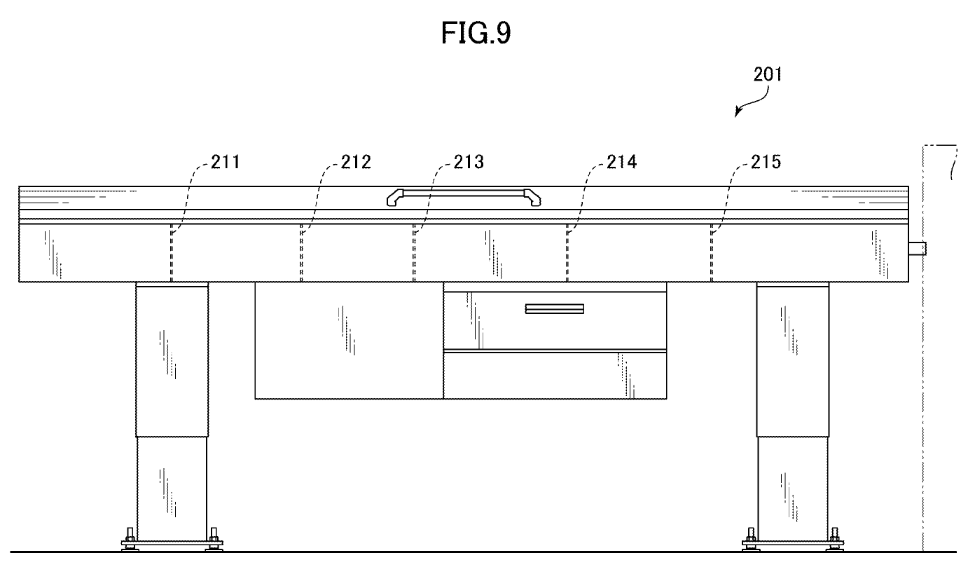

FIGS. 8 to 10 are a schematic plan view, a schematic front view, and a schematic cross-sectional view, respectively, showing a bar feeder 201 according to a second embodiment of the present invention.

As shown in FIGS. 8 to 10, the bar feeder 201 includes five bar guide shelves 211 to 215, each of which is inclined at approximately 20 degrees relative to a horizontal direction. The number of bar guide shelves is not limited to five. Each of the bar guide shelves 211 to 215 is a narrow-width member (e.g., a member having a width of approximately3 mm) (which may also be referred to as a “bar guide rail”).

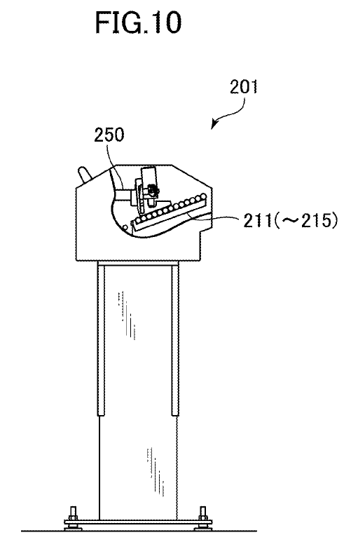

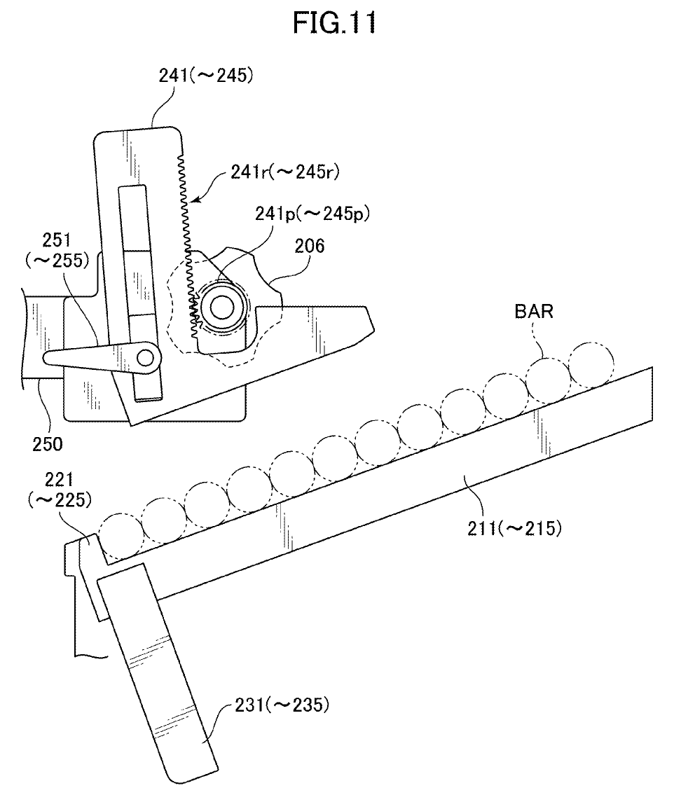

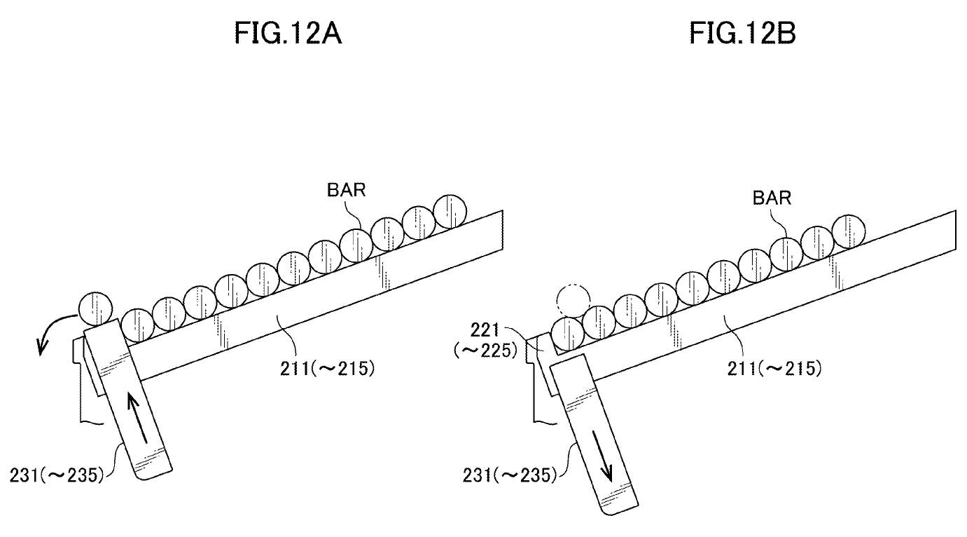

FIG. 11 is an enlarged view of the essential part of FIG. 10. As shown in FIG. 11, a corresponding stopper portion 221 to 225 is provided at a lower end of each of the bar guide shelves 211 to 215. Furthermore, as shown in FIGS. 12A and 12B, a corresponding push-up member 231 to 235 is provided to push up a single bar (bar material) that has been guided to the lower end of each of the bar guide shelves 211 to 215 from the lower side to the upper side, causing it to pass over the corresponding stopper portion 221 to 225.

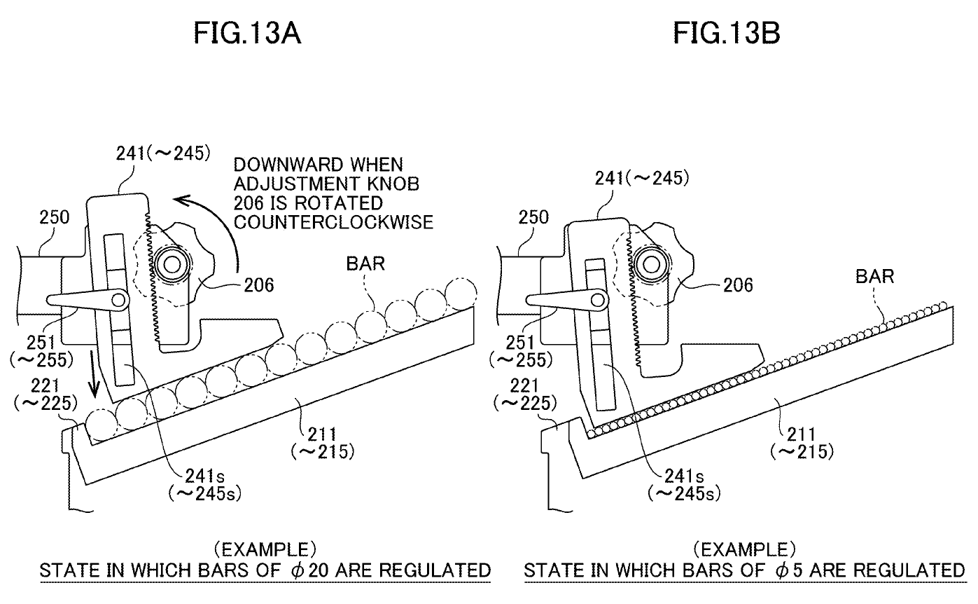

Meanwhile, returning to FIG. 11, a corresponding regulating member 241 to 245 is provided above an upper surface of each of the bar guide shelves 211 to 215. Each of the regulating members 241 to 245 is supported by a support mechanism 250 such that it can be vertically moved relative to the support mechanism 250. Each of the regulating members 241 to 245 is also a narrow-width member (e.g., a member having a width of approximately 3 mm). A bottom surface of each of the regulating members 241 to 245 is maintained in parallel alignment with the corresponding bar guide shelf 211 to 215. As shown in FIGS. 13A and 13B, the height of each of the regulating members 241 to 245 can be adjusted depending on the diameter of each of the bars to be fed. This adjustment enables smooth guidance of the bars.

More specifically, each of the regulating members 241 to 245 has a corresponding sliding slot hole 241s to 245s, which is configured to slide relative to the support mechanism 250 in a substantially vertical direction (more precisely, at an angle of approximately 5 degrees inclined from a vertical direction). Thereby, each of the plurality of regulating members 241 to 245 is configured to be slidable at an angle of approximately 75 degrees relative to the corresponding bar guide shelf 211 to 215 (which is inclined at approximately 20 degrees relative to the horizontal direction). Accordingly, not only bars having a circular cross-sectional shape but also bars having various other cross-sectional shapes (for example, a hexagonal cross-sectional shape) can be stably pushed up by the plurality of push-up members 231 to 235 to pass over the plurality of stopper portions 221 to 225.

A user of the bar feeder 201 can move the position of each of the regulating members 241 to 245, via a rotational operation of an adjustment knob 206, to adjust its height depending on the diameter of the bars.

Specifically, in the present embodiment, in each of the regulating members 241 to 245, corresponding rack teeth portions 241r to 245r are provided on a wall surface that is parallel to the corresponding slot hole 241s to 245s. Each of the rack teeth portions 241r to 245r engages with a corresponding pinion gear 241p to 245p, which is fixed to a cofunctioning shaft 204. The adjustment knob 206 is also fixed to the cofunctioning shaft 204 for the rotational operation by the user. The cofunctioning shaft is rotatably supported by the support mechanism 250.

According to this structure, when the user rotates the adjustment knob 206, the cofunctioning shaft 204 and pinion gears 241p to 245p are also rotated, which causes the regulating members 241 to 245 to integrally move in the vertical direction via the rack teeth portions 241r to 245r. Accordingly, the five regulating members 241 to 245 can be integrally positioned at a desired height relative to the support mechanism 250.

After the positioning step (after the adjustment knob 206 has been rotated), the position of each of the regulating members 241 to 245 relative to the support mechanism 250 is fixable by tightening a corresponding locking lever 251 to 255 (the position (its height) becomes adjustable again by loosening the corresponding locking lever 251 to 255). The regulating members 241 to 245 and the cofunctioning shaft 204 are biased downward by their own weight. Therefore, their downward sliding movement can be achieved simply by releasing the locking levers 251 to 255.

### Effects of Second Embodiment

According to the bar feeder 201 of the present embodiment as well, as described above, the height of each of the regulating members 241 to 245 can be adjusted depending on the diameter of the bars to be fed (see FIGS. 13A and 13B), and therefore the smooth guidance of the bars can be accomplished. In particular, this adjustment can be effective in avoiding a state in which two bars are overlapped vertically during the guidance.

In addition, according to the bar feeder 201 of the present embodiment, because the five positioning mechanisms (the rack teeth portions 241r to 245r and the pinion gears 241p to 245p) are configured to synchronously function together such that the five regulating members 241 to 245 are integrally positioned at a desired height relative to the support mechanism 250, the task of positioning the five regulating members 241 to 245 can be significantly facilitated.

In particular, according to the bar feeder 201 of the present embodiment, because the five positioning mechanisms (the rack teeth portions 241r to 245r and the pinion gears 241p to 245p) are configured to synchronously function together via the cofunctioning shaft 204, the step (action) of causing the five positioning mechanisms to synchronously function together can be facilitated. In addition, it is possible to implement this type of structure at a lower cost for causing the five positioning mechanisms to synchronously function together.

Furthermore, according to the bar feeder 201 of the present embodiment, because each of the regulating members 241 to 245 is configured to be slidable relative to the support mechanism 250, the task of positioning the plurality of regulating members 241 to 245 can be further facilitated. In addition, it is possible to implement this type of structure at a lower cost for positioning (adjusting the heights of) the regulating members 241 to 245.

In addition, according to the bar feeder 201 of the present embodiment, the positioning step of the five regulating members 241 to 245 is possible only when the locking levers 251 to 255 are released. Therefore, the positions of the five regulating members 241 to 245 after having been positioned can be stably maintained by actuation of the locking levers 251 to 255.

In addition, according to the bar feeder 201 of the present embodiment, by making use of the engagement between the rack teeth portions 241r to 245r and the pinion gears 241p to 245p, the five regulating members 241 to 245 are integrally positioned at a desired height. Therefore, the task of positioning the five regulating members 241 to 245 with a higher degree of accuracy can be facilitated. In addition, it is possible to implement this type of structure at a lower cost for positioning (adjusting the positions of) the five regulating members 241 to 245 with a higher degree of accuracy.

Furthermore, according to the bar feeder 201 of the present embodiment, by the rotational operation of the adjustment knob 206 by the user, the five regulating members 241 to 245 are integrally positioned at a desired height. Therefore, the task of positioning the five regulating members 241 to 245 with a higher degree of accuracy can be further facilitated. In addition, it is possible to implement this type of structure at a lower cost for positioning (adjusting the positions of) the five regulating members 241 to 245 with a higher degree of accuracy.

The diameter of the bars that the bar feeder 201 of the present embodiment can handle is also approximately 1 mm to 38 mm (φ 1 to φ 38), and the length of the bars that the bar feeder 201 of the present embodiment can handle is also approximately 1 m to 4 m. Furthermore, in the present embodiment as well, the material of the bars is not particularly limited, but is, for example, iron.

### Modified Example of Second Embodiment

In the structure described above, the five locking levers 251 to 255 are provided correspondingly to the respective regulating members 241 to 245. However, in view of their function, just one locking lever is sufficient, which means that the number of locking levers can be appropriately reduced.

Alternatively, other known locking mechanism(s) may be adopted instead of the locking levers 251 to 255.

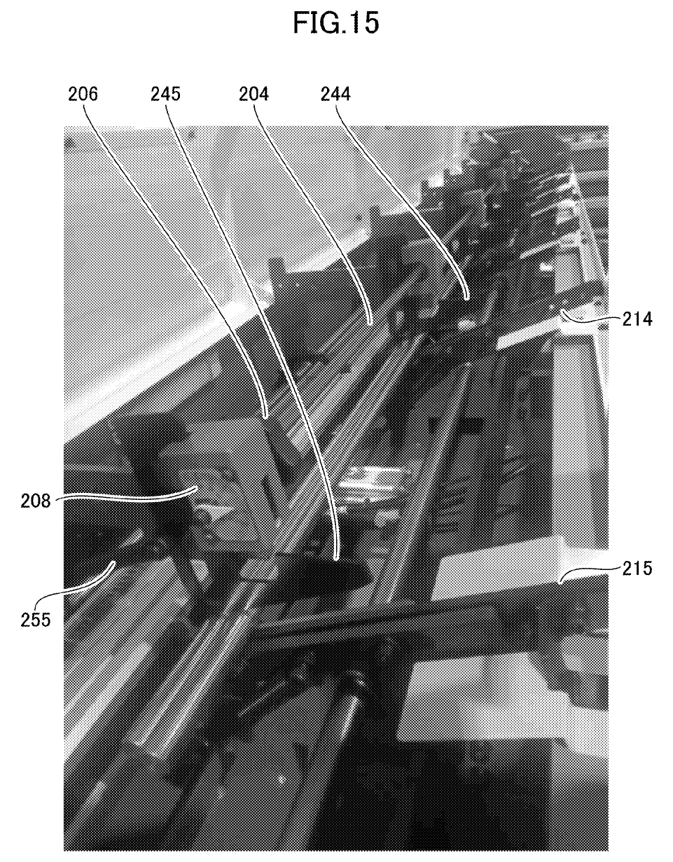

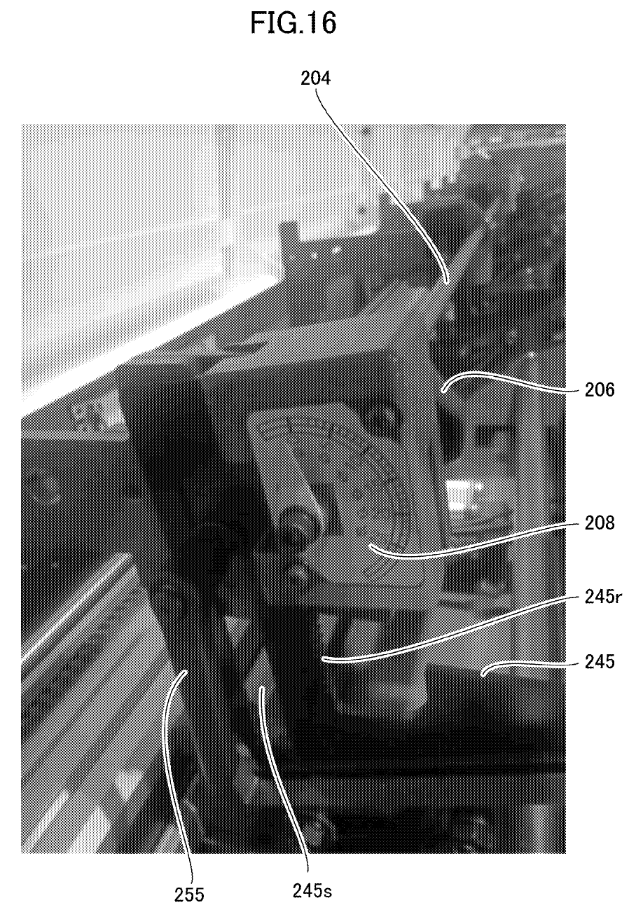

In addition, in the present embodiment, it is further preferable that the bar feeder 201 further includes a scale 208 indicating an index corresponding to a rotational amount of the adjustment knob 206 (see FIGS. 15 and 16). According to this further preferable feature, the task of positioning the five regulating members 241 to 245 with a higher degree of accuracy can be further facilitated. For example, it is preferable that the index may denote numerical values corresponding to the diameter of the bars to be fed (see FIG. 16).

### Specific Example of Second Embodiment Photographs

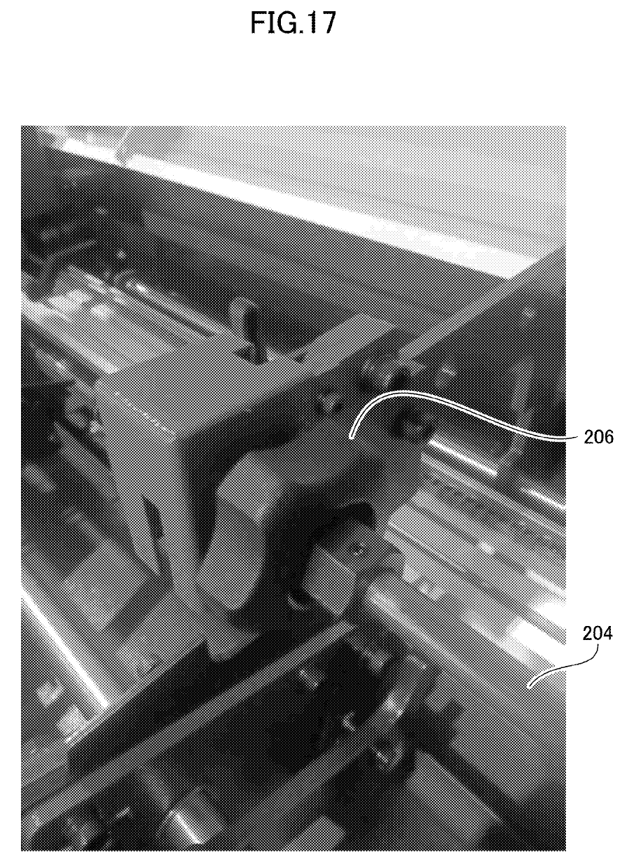

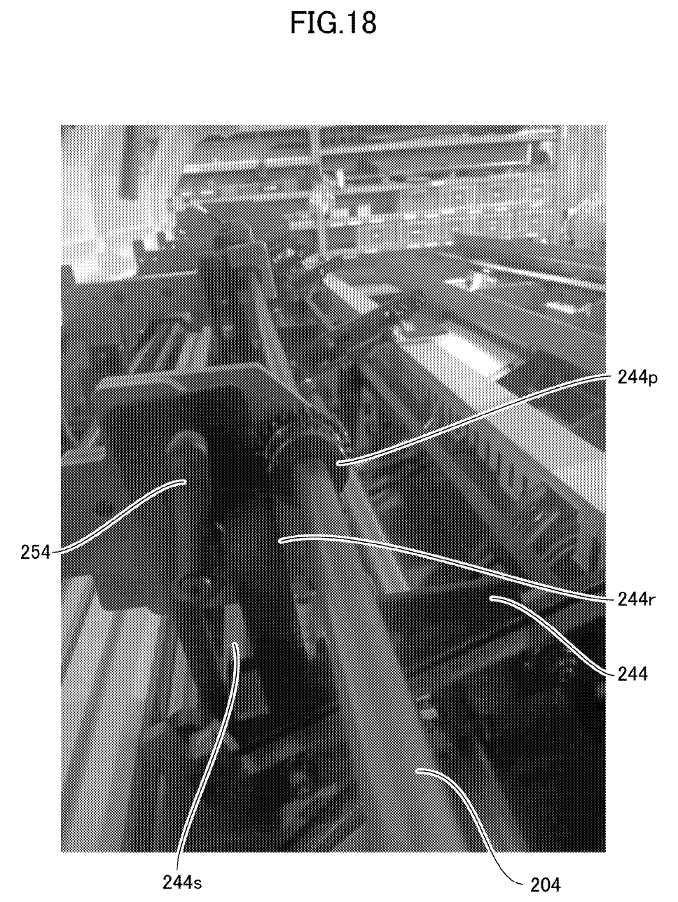

For reference, FIG. 15 is a photograph corresponding to a perspective view of the bar feeder 201 according to the second embodiment of the present invention. In addition, FIG. 16 is a photograph corresponding to a perspective view showing an example of the scale 208, FIG. 17 is a photograph corresponding to a perspective view showing an example of the adjustment knob 206, and FIG. 18 is a photograph corresponding to an exploded view showing an example of the pinion gear 244p.

### Explanation of Signs

1 Bar Feeder (First Embodiment)

4 Linkage Shaft

11 to 15 Bar Guide Shelf

21 to 25 Stopper Portion

31 to 35 Push-Up Member

41 to 45 Regulating Member

41s to 45s Slot Hole

50 Support Mechanism

51 to 55 Locking Lever

100 Bar Feeder (Conventional)

111 to 115 Bar Guide Shelf

121 to 125 Stopper Portion

131 to 135 Push-Up Member

141 to 145 Regulating Member

141s to 145s Slot Hole

150 Support Mechanism

151 to 155 Locking Lever

201 Bar Feeder (Second Embodiment)

204 Cofunctioning Shaft

206 Adjustment Knob

208 Scale

211 to 215 Bar Guide Shelf

221 to 225 Stopper Portion

231 to 235 Push-Up Member

241 to 245 Regulating Member

241p to 245p Pinion Gear

241r to 245r Rack Teeth Portion

241s to 245s Slot Hole

250 Support Mechanism

251 to 255 Locking Lever

What is claimed is:

1. A bar feeder comprising:
a plurality of bar guide shelves, each of which is inclined relative to a horizontal direction,
a plurality of stopper portions, each of which is provided at a lower end of a corresponding bar guide shelf of the plurality of bar guide shelves,
a plurality of push-up members, each of which is provided to push up a single bar that has been guided to a lower end of a corresponding bar guide shelf of the plurality of bar guide shelves from a lower side to an upper side in order to cause the single bar to pass over a corresponding stopper portion of the plurality of stopper portions,
a plurality of regulating members, each of which is provided above an upper surface of the corresponding bar guide shelf and is vertically movable, and
a support mechanism configured to support the plurality of regulating members,
wherein
the plurality of bar guide shelves is arranged along a longitudinal direction of a bar to be fed,
the plurality of regulating members is also arranged along the longitudinal direction of the bar to be fed, and
the plurality of regulating members is integrally connected to each other such that the plurality of regulating members is integrally positioned at a desired height relative to the support mechanism.

2. The bar feeder according to claim 1, wherein
each of the plurality of regulating member is configured to be slidable relative to the support mechanism.

3. The bar feeder according to claim 2, wherein
positioning of the plurality of regulating members is possible only when a locking lever is released.

4. The bar feeder according to claim 1, wherein
the plurality of regulating members is slidable along a track that enables not only bars having a circular cross-sectional shape but also bars having various other cross-sectional shapes to be stably pushed up by the plurality of push-up members and to pass over the plurality of stopper portions.

5. A bar feeder comprising:
a plurality of bar guide shelves, each of which is inclined relative to a horizontal direction,
a plurality of stopper portions, each of which is provided at a lower end of a corresponding bar guide shelf of the plurality of bar guide shelves,
a plurality of push-up members, each of which is provided to push up a single bar that has been guided to a lower end of a corresponding bar guide shelf of the plurality of bar guide shelves from a lower side to an upper side in order to cause the single bar to pass over a corresponding stopper portion of the plurality of stopper portions,
a plurality of regulating members, each of which is provided above an upper surface of the corresponding bar guide shelf and is vertically movable,
a support mechanism configured to support the plurality of regulating members, and
a plurality of positioning mechanisms, each of which is configured to position a corresponding regulating member of the plurality of regulating members to a desired height relative to the support mechanism,
wherein
the plurality of bar guide shelves is arranged along a longitudinal direction of a bar to be fed,
the plurality of regulating members is also arranged along the longitudinal direction of the bar to be fed, and
the plurality of positioning mechanisms is configured to synchronously function together such that the plurality of regulating members is integrally positioned at a desired height relative to the support mechanism.

6. The bar feeder according to claim 5, wherein
the plurality of positioning mechanisms is configured to synchronously function together via a cofunctioning shaft.

7. The bar feeder according to claim 6, wherein
each of the plurality of regulating member is configured to be slidable relative to the support mechanism.

8. The bar feeder according to claim 7, wherein
each of the plurality of positioning mechanisms has a locking lever.

9. The bar feeder according to claim 6, wherein
each of the plurality of positioning mechanisms has a pinion gear fixed to the cofunctioning shaft.

10. The bar feeder according to claim 6, wherein
the cofunctioning shaft is configured to be rotated via an adjustment knob.

11. The bar feeder according to claim 6, further comprising
a scale indicating an index corresponding to a rotational amount of the adjustment knob.

12. The bar feeder according to claim 7, wherein
the plurality of regulating members is slidable along a track that enables not only bars having a circular cross-sectional shape but also bars having various other cross-sectional shapes to be stably pushed up by the plurality of push-up members and to pass over the plurality of stopper portions.
